(19) United States
(12) Patent Application Publication
(10) Pub. No.: US 2016/0140816 A1
(43) Pub. Date: May 19, 2016

(54) SECURE MOBILE DEVICE HOUSING

(71) Applicants: Franklyn W. Gulick, Binghamton, NY (US); Gary Robert Page, Chenango Forks, NY (US)

(72) Inventors: Franklyn W. Gulick, Binghamton, NY (US); Gary Robert Page, Chenango Forks, NY (US)

(21) Appl. No.: 14/939,657

(22) Filed: Nov. 12, 2015

Related U.S. Application Data
(60) Provisional application No. 62/079,906, filed on Nov. 14, 2014.

(51) Int. Cl. G08B 13/08; H04B 1/3888

(52) U.S. Cl. CPC G08B 13/08; H04B 1/3888

(57) ABSTRACT

A system for mobile device security is described. The system includes a first housing to at least partially enclose a first portion of a mobile device and a second housing to at least partially enclose a second portion of the mobile device. The first housing is to couple to the second housing and the first housing is to uncouple from the second housing only upon application of a secure key. The housing can be a case for a mobile device.

### BACKGROUND OF THE INVENTION

This application claims the benefit of and priority to U.S. Provisional Patent Application Ser. No. 62/079,906, filed Nov. 14, 2014, and entitled “Secure Mobile Device Housing,” the entirety of which is incorporated herein by reference.

Mobile devices, such as mobile phones, tablets, and other mobile devices, are becoming increasingly popular. As these devices are typically expensive, a user typically purchase cases designed to protect the mobile devices from damage. These cases can protect the device from physical damage, such as damage caused by dropping the device or immersing the device in water. Additionally, as the costs, and associated value, of mobile devices increase, mobile devices are becoming increasing targets for theft.

### SUMMARY OF THE INVENTION

A system and method for mobile device security is described herein. In an embodiment, a system includes a first housing to at least partially enclose a first portion of a mobile device and a second housing to at least partially enclose a second portion of the mobile device. The first housing is to couple to the second housing and the first housing is to uncouple from the second housing only upon application of a secure key.

In another embodiment, a case for a mobile device is described. The case includes a housing to at least partially enclose the mobile device. The housing includes a first piece and a second piece to lock together around the mobile device. The first piece and the second piece are to be unlocked only with a secure key.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is an illustration of an example of a case including mobile device security;

FIG. 2 is a high-level diagram showing the components of a system; and

FIG. 3 is a flow-diagram of an example of a method of providing security to a mobile device.

The attached drawings are for purposes of illustration and are not necessarily to scale.

### DETAILED DESCRIPTION OF THE INVENTION

In the following description, some aspects will be described in terms that would ordinarily be implemented as software programs. Those skilled in the art will readily recognize that the equivalent of such software can also be constructed in hardware, firmware, or micro-code. Because data-manipulation algorithms and systems are well known, the present description will be directed in particular to algorithms and systems forming part of, or cooperating more directly with, systems and methods described herein. Other aspects of such algorithms and systems, and hardware or software for producing and otherwise processing the signals involved therewith, not specifically shown or described herein, are selected from such systems, algorithms, components, and elements known in the art. Given the systems and methods as described herein, software not specifically shown, suggested, or described herein that is useful for implementation of any aspect is conventional and within the ordinary skill in such arts.

Mobile devices are being increasingly relied upon by consumers. As the cost and importance of these devices increases, users are increasingly employing ways to protect the mobile devices from damage, typically in the form of a protective case. With the increase in cost, mobile devices are also increasingly becoming targets for theft. By incorporating security measures into a case, as described in the following description and in Appendix A, the entirety of which is incorporated herein, a user can provide both protection from physical damage and theft protection to a mobile device.

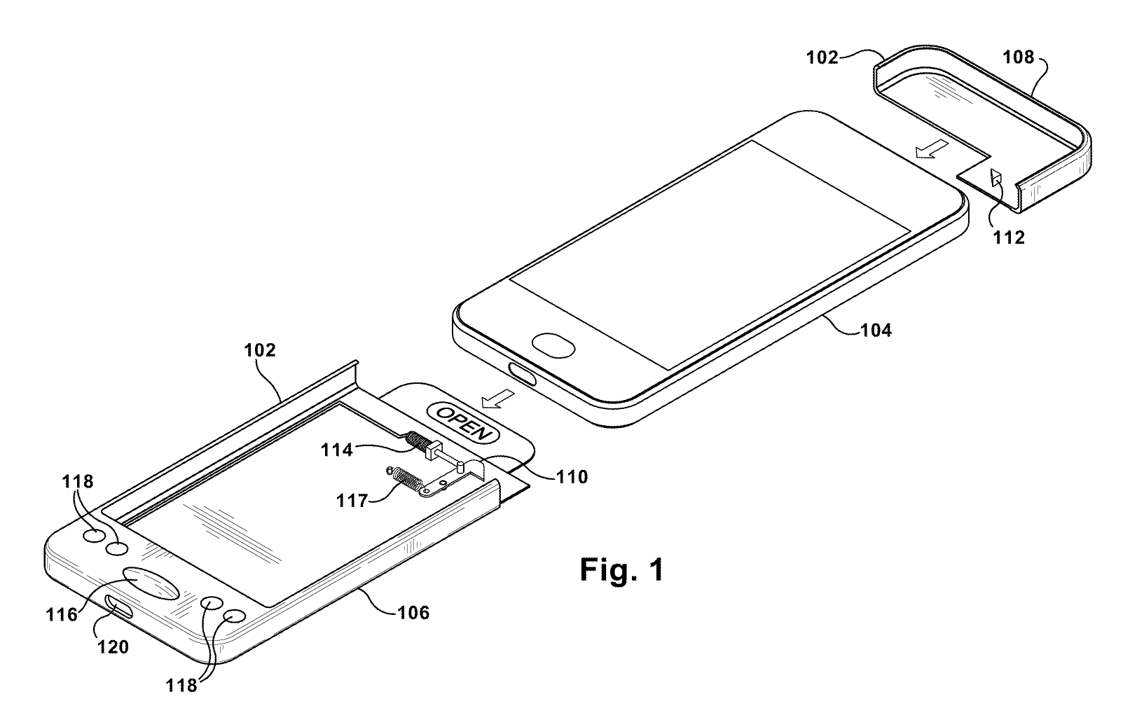

FIG. 1 is an illustration of an example of a case including mobile device security. The case can be formed of any suitable material, such as, for example, a plastic or a metal. A case 102 can at least partially enclose a mobile device 104. For example, the case 102 can fully enclose the mobile device 104, enclose a portion of the mobile device 104, enclose only the edges of the mobile device 104 in a frame, or any other suitable design. The mobile device 104 can be any type of device, such as, for example, a cellular phone or a tablet.

In an embodiment, the case 102 can include multiple pieces. For example, the case can include a first piece 106 and a second piece 108. The first piece 106 can be designed to couple to the second piece 108. The first piece 106 can be designed to couple to the second piece 108 with a secure key such that the first piece 106 is locked to the second piece 108. When the first piece 106 is coupled to the second piece 108, the first piece 106 and the second piece 108 can only be uncoupled with the secure key. In an example, the secure key can be a physical key, such as a tool, a key, a keycard, or any other suitable type of physical key. In another example, the secure key can be an electronic key, such as an alphanumeric code or a user's fingerprint.

Introduction of the secure key can activate a locking mechanism to lock the first piece 106 to the second piece 108. For example, the first piece 106 can include a locking arm 110, such as a swiveling locking arm, configured to engage an upper lock 112 included in the second piece 108. The locking arm 110 can be activated in any suitable manner. For example, an electromagnetic pin or solenoid 114 can activate the locking arm 110 to engage the upper lock 112 when the secure key is introduced. Similarly, the locking arm 110 can disengage from a locked position when the secure key is again introduced. The locking mechanism can also include a spring 117 to activate the locking arm 110.

If the case 102 is removed from the mobile device 104 without using the secure key, an alarm 116 can be activated. The alarm 116 can be any suitable type of alarm, such as a visual alarm, an audible alarm, or a combination thereof. For example, the visual alarm can be a light emitting diode (LED). In an example, the type of alarm can be configured by a user. In another example, the type of alarm can be configured during the manufacturing process. The alarm can be disarmed by a user, via application of the secure key.

The case 102 can include a user interface. For example, the case 102 can include a plurality of buttons 118 to allow the user to interact with the case. In another example, the buttons 118 can also allow the user to interact with the mobile device 104 when the mobile device 104 is enclosed in the case 102. The buttons can be physical buttons or virtual buttons.

The case 102 can also include an interface port 120. The interface port 120 can be any suitable type of port such as a Universal Serial Bus (USB) port, a mini-USB port, a micro-USB port, or any other suitable type of port. In an example, a model of the case 102 can be designed to fit a particular mobile device 104 and the interface port 120 can be the same type of interface port 120 as is included in the mobile device 104. The interface port 120 can allow the case 102 and/or the mobile device 104 to be coupled to another device, such as a power source, a display device, or any other suitable type of device. In the example, the case 102 can include a power source, such as a battery, and the interface port 120 can couple the case 102 and/or the mobile device 104 to an outside power source so that the case 102 and/or the mobile device 104 can be charged.

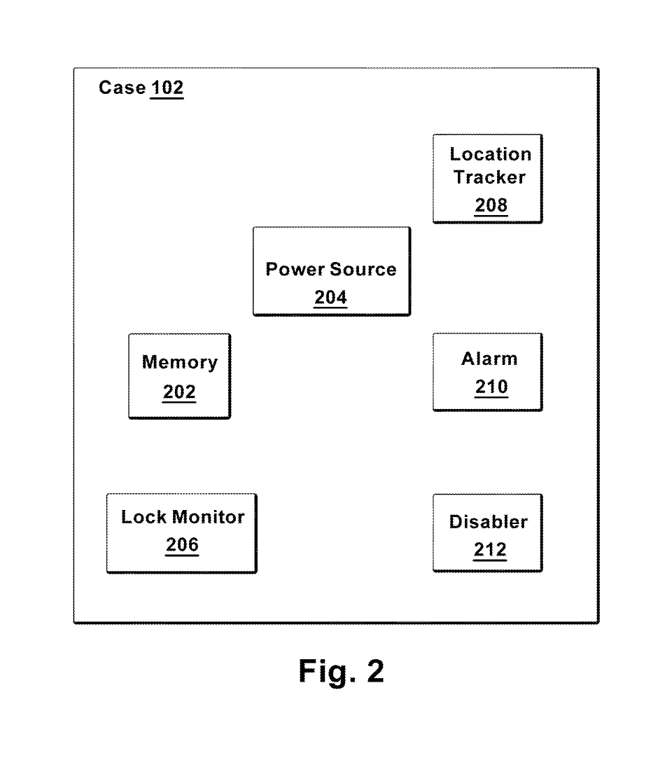

FIG. 2 a high-level diagram showing the components of a system. The components can be electronic components of the case 102. In an example, the components can be included in a printed circuit board. In a further example, this printed circuit board can be introduced into the mobile device 104, such as via the interface port of the mobile device, to interact with the hardware and/or software of the mobile device 104.

The case 102 can include memory 202. This memory can act as additional memory to the mobile device 104 and can be any suitable type of memory. The case can also include a power source 204, such as a battery. For example, the power source 204 can be a lithium-ion battery. The power source 204 can provide power to operate the features of the case 102. Additionally, the power source 204 can act as a backup power source for the mobile device 104. The power source 204 can be recharged via a charging cable coupled to the interface port 120 of the case 102.

The case 102 can also include a lock monitor 206. The lock monitor 206 can determine the state of the lock, i.e., whether the locking arm is activated, locking the first piece 106 to the second piece 108, or whether the locking arm is deactivated. Additionally, the lock monitor 206 can determine if the secure key has been used. In an example, the lock monitor 206 can activate an alarm 210 if the lock monitor 206 determines that the state of the lock has changed without use of the secure key.

The alarm 210 can be any suitable type of alarm. For example, the alarm can be an audible alarm, a visual alarm, or a combination thereof. In addition, the alarm 210 can be activated for a variety of reasons. For example, the alarm 210 can be activated when the case 102 is removed from the mobile device 104 without use of the secure key. In another example, the alarm 210 can be activated when a charging cable is removed from the interface port 120 without use of the secure key. Activation of the alarm 210 can be prevented or the alarm 210 can be disarmed by use of the secure key. In an example, the alarm 210 can include different levels, such as different tones or different colors, depending on the reason the alarm 210 was activated.

The case 102 can also include a location tracker 208. The location tracker 208 can be used to locate the mobile device 104. For example, the location tracker 208 can be activated remotely by an owner. If the location tracker 208 verifies that the mobile device 104 has been stolen, a disabler 212 can be activated. The disabler 212 can temporarily or permanently disable the functions of the mobile device 104. For example, the mobile device 104 can be physically damaged by the case. In another example, the software of the mobile device 104 can be damaged, such as by the introduction of a virus. In this way, the mobile device 104 can be rendered unusable, defeating the purpose of stealing the mobile device 104. In addition, if the case 102 is removed from the mobile device 104 without use of the secure key, the disabler 212 can be activated to temporarily or permanently incapacitate the mobile device 104.

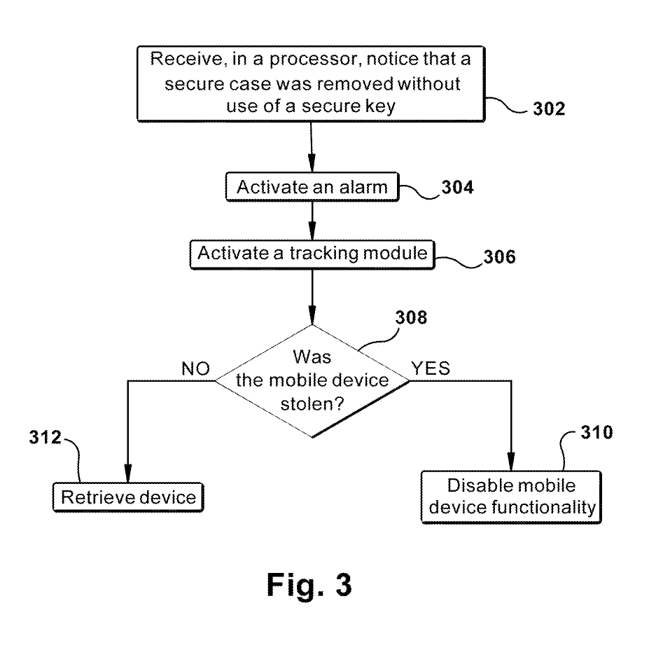

FIG. 3 is a flow-diagram of an example of a method of providing security to a mobile device. At block 302, notice can be received in a processor that a secure case was removed from a mobile device without use of a secure key. The processor can be a component included in the case, or the processor can be included in the mobile device. The secure key can be a physical key or an electronic key.

At block 304, and alarm can be activated. The alarm can be any suitable type of alarm. For example, the alarm can be an audible alarm, a visual alarm, or a combination thereof. At block 306, a tracking module can be activated. In an example, the tracking module can be a tracking chip included in the case. The information provided by the tracking module can be used to determine 308 if the mobile device has been stolen or simply misplaced. This determination can be made by the owner or by an analysis program.

If the device was stolen, at block 310, the mobile device functionality can be disabled. The functionality can be disabled in a variety of ways. For example, the case can be designed to physically damage the mobile device. In another example, the case can damage the software of the mobile device, such as through the introduction of a virus. The functionality can be disabled permanently or temporarily. In an example, the owner can determine if the disability is permanent or temporary. In another example, the permanence of the disability can be determined during manufacturing. If the device was not stolen, the owner can retrieve 312 the mobile device from the location indicated by the tracking module.

The invention is inclusive of combinations of the aspects described herein. References to “a particular aspect” and the like refer to features that are present in at least one aspect of the invention. Separate references to “an aspect” (or “embodiment”) or “particular aspects” or the like do not necessarily refer to the same aspect or aspects; however, such aspects are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

What is claimed is:

1. A system for mobile device security, comprising:
a first housing to at least partially enclose a first portion of a mobile device; and
a second housing to at least partially enclose a second portion of the mobile device,
wherein the first housing is to couple to the second housing, and
wherein the first housing is to uncouple from the second housing only upon application of a secure key.

2. The system of claim 1, wherein the secure key comprises a physical key.

3. The system of claim 1, wherein the secure key comprises an electronic key.

4. The system of claim 1, wherein if the case is removed without the secure key, an alarm is activated.

5. The system of claim 1, wherein if the case is removed without the secure key, functionality of the mobile device is to be disabled.

6. The system of claim 1, further comprising a locking arm to couple the first housing and the second housing.

7. The system of claim 6, wherein the locking arm is activated by one of a solenoid, an electromagnetic pin, or a combination thereof.

8. A case for a mobile device, comprising:
a housing to at least partially enclose the mobile device, the housing comprising:
a first piece and a second piece to lock together around the mobile device,
wherein the first piece and the second piece are to be unlocked only with a secure key.

9. The case of claim 8, wherein the secure key comprises a physical key.

10. The case of claim 9, wherein the secure key comprises an electronic key.

11. The case of claim 10, wherein the electronic key comprises a secure code, the secure code comprising one of an alphanumeric code and a user fingerprint.

12. The case of claim 9, wherein the secure key is set by a device owner.

13. The case of claim 8, wherein the first piece comprises a locking arm to engage the second piece.

14. The case of claim 8, further comprising an alarm to be activated if the case is removed from the mobile device without the secure key.

15. The case of claim 8, wherein the case comprises an interface port for a charging cable.

16. The case of claim 15, wherein an alarm is to be activated when the charging cable is removed without the secure key.

17. The case of claim 8, wherein functionality of the mobile device is to be disabled when the case is removed without the secure key.

18. The case of claim 8, further comprising a tracker to determine a location of the mobile device.
